(19) United States
(12) Patent Application Publication
(10) Pub. No.: US 2008/0064779 A1
(43) Pub. Date: Mar. 13, 2008

(54) Method For Producing Polyether Alcohols And Polyurethanes

(75) Inventors: Anja Biedermann, Diepholz (DE); Regina Pretzsch, Stemwede-Haldem (DE); Stefan Dinsch, Schipkau (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF AKTIENGESSELLSCHAF, LUDWIGSHAFEN (DE)

(21) Appl. No.: 11/628,465

(22) PCT Filed: Jun. 9, 2005
(86) PCT No.: PCT/EP05/06197

§ 371 Date: Dec. 4, 2006

(30) Foreign Application Priority Data
Jun. 16, 2004 (DE) 102004028769.4

(51) Int. Cl. C08G 71/04

(52) U.S. Cl. 521/170

(57) ABSTRACT

Process for the preparation of polyether alcohols, wherein the alkoxylation is carried out in the presence of sheet silicates.

The invention relates to a process for preparing polyether alcohols having a functionality toward isocyanates of preferably from 1.7 to 6, particularly preferably from 1.7 to 4, very particularly preferably from 1.7 to 3, in particular from 2 to 3, and a hydroxyl number of preferably from 10 mg KOH/g to 500 mg KOH/g, particularly preferably from 10 mg KOH/g to 100 mg KOH/g, very particularly preferably from 10 mg KOH/g to 60 mg KOH/g, in particular from 25 mg KOH/g to 35 mg KOH/g, preferably by alkoxylation of starter substances, preferably alcohols or amines, particularly preferably alcohols having preferably from 2 to 6, particularly preferably from 2 to 4, in particular 2 or 3, hydroxyl groups, with the alkoxylation being carried out in the presence of sheet silicates, and also polyether alcohols obtainable in this way, in particular polyether alcohols, comprising exfoliated sheet silicates. Furthermore, the invention relates to a process for producing polyurethanes, for example compact or cellular, crosslinked or thermoplastic polyurethanes, e.g. flexible, semirigid or rigid polyurethane foams, by reacting
(a) polyisocyanates with
(b) compounds having hydrogen atoms which are reactive toward isocyanate groups,
   wherein the polyether alcohols of the invention are used as (b) compounds having hydrogen atoms which are reactive toward isocyanate groups, and also polyurethanes obtainable in this way, in particular flexible polyurethane foams.

The use of sheet silicates in polyurethanes is known. EP-A-1209189 describes the use of nanocomposites in PUR foams. The clays serve as nucleating agents and gas barriers, resulting in an improvement in the thermal conductivity. Exfoliation of the sheet silicates does not occur.

DE-A-10032334 describes the incorporation of silicate-containing nanofillers without adverse effects on the bulk density. It is disclosed that expanded sheet silicates are delaminated and preferably incorporated into the cell struts in PUR foam production. Cloisite 30 A was used as sheet silicate and is incorporated by stirring into the A component and immediate foaming with the isocyanate. A disadvantage of the fillers disclosed here is that they settle very quickly in the A component, which results in low storage stability of the A component.

WO 03/059817 describes a nanodispersion which comprises a sheet silicate and a compound intercalated in the sheet silicate and is prepared by intensive mixing of the sheet silicates with polyols. This document makes clear reference to the problems associated with introducing the sheet silicates into the polyols and exfoliating the sheet silicates. According to WO 03/059817, only sheet silicates which have been organically modified with quaternary ammonium compounds and bear hydrophilic end groups are suitable, and these have to be incorporated and dispersed in the polyols in an additional step.

Disadvantages of the known technical teachings is the only low content of exfoliated sheet silicate in polyols because of the viscosity increase and the low degree of exfoliation achieved and also a complicated dispersion step, as a result of which advantages arising from the use of the nanoparticles cannot be exploited satisfactorily.

It was therefore an object of the present invention to develop an economical process for preparing mixtures comprising polyether alcohols and sheet silicates in which the sheet silicates are virtually completely exfoliated.

This object has been able to be achieved by a process for preparing polyether alcohols having a functionality toward isocyanates of preferably from 1.7 to 6, particularly preferably from 1.7 to 4, very particularly preferably from 1.7 to 3, in particular from 2 to 3, and a hydroxyl number of preferably from 10 mg KOH/g to 500 mg KOH/g, particularly preferably from 10 mg KOH/g to 100 mg KOH/g, very particularly preferably from 10 mg KOH/g to 60 mg KOH/g, in particular from 25 mg KOH/g to 35 mg KOH/g, preferably by alkoxylation of starter substances, preferably alcohols or amines, particularly preferably alcohols having preferably from 2 to 6, particularly preferably from 2 to 4, in particular 2 or 3, hydroxyl groups, preferably using ethylene oxide and/or propylene oxide as alkylene oxide, in which the alkoxylation is carried out in the presence of sheet silicates.

For the purposes of the present invention, sheet silicates are the silicate structures having two-dimensional layers of SiO₄ tetrahedra which are known from the prior art, (in the prior art also referred to as layer silicates or phyllosilicates). Examples of suitable sheet silicates are preferably naturally occurring clay minerals, montmorillonite, bentonite, mica, kaolinite, boehmite, smectite, hectorite, vermiculite and mixtures thereof. Examples are given in the publication ,,Dispersionen und Emulsionen”, Lagaly, Schulz, Zimehl, Steinkopf Verlag, Darmstadt. Preference is given to using bentonite, montmorillonites, including those which can be procured, for example, from Südchemie and/or Southern Clay.

In the polymerization of the alkylene oxides, the hydroxyalkyl chains grow between the layers of the sheet silicates, leading to separation of these layers from one another, i.e. to the desired exfoliation. The important advantage of this process of the invention is the favorable combination of two process steps: the sheet silicate is exfoliated, i.e. delaminated, in parallel with the preparation of the polyether alcohols in one process step. Thus, in the subsequent use of the polyether alcohol, previously exfoliated sheet silicates are used and these do not firstly have to be stirred in, dispersed or delaminated by means of high shear energy or delaminated during foaming.

The preparation of polyether alcohols, hereinafter also referred to as polyetherols, by alkoxylation, e.g. by the method of anionic polymerization, has been known for a long time. The process of the invention is preferably carried out with the sheet silicate being taken up in (mixed with) the starter substance or substances and alkylene oxide subsequently being introduced. The sheet silicates are preferably mixed well with the starter substance(s) and brought to the desired starting temperature of the alkoxylation reaction. The sheet silicates are preferably taken up homogeneously in the low molecular weight starter substances at temperatures of from 80 to 150° C. with sufficient mixing action, leading to uniform distribution in the starter mixture. During the reaction with alkylene oxides to form relatively high molecular weight products, the homogeneity of the mixtures is substantially maintained, since the starter mixture with the sheet silicate taken up therein is subjected to a controlled addition reaction with alkylene oxides. The continuous increase in the chain lengths or the molecular weights maintains the homogeneous distribution. This homogeneous distribution is generally difficult to obtain when fresh sheet silicates are mixed into the fully reacted polyetherol.

As starter substances, it is possible to use generally known compounds which preferably have hydroxyl and/or amino groups onto which the alkylene oxides can be added. The use of, for example, monosaccharides, disaccharides or polysaccharides and further high-functionality compounds for the synthesis of high-functionality polyetherols is a known and frequently described method of preparing polyetherols, in particular those which are intended for use in rigid PUR foams. It is customary to alkoxylate sucrose in admixture with liquid costarters such as diols, triols or amines. Depending on the proportion of this costarter, a more or less high functionality of the polyetherol is obtained. In the preparation of flexible foam polyols, preference is given to using, for example, trifunctional, hydroxyl-containing starter substances, either alone or in admixture with glycols such as monoethylene, diethylene or triethylene glycols or monopropylene, dipropylene or tripropylene glycols or else tetrols such as pentaerythritol and diglycerol. For example, the following compounds can be used as starter substances: water, alkanolamines, dialkanolamines, dihydric and/or polyhydric alcohols such as ethanediol, 1,2- and 1,3-propanediol, diethylene glycol, dipropylene glycol, 1,4-butanediol, 1,6-hexanediol, glycerol, pentaerythritol, sorbitol and/or sucrose. Preference is given to using at least one of the following compounds as starter substances: glycerol, trimethylolpropane, diethylene glycol, monoethylene glycol, propylene glycol, triethylene glycol, N,N′-bis(3-aminopropyl)ethylenediamine, vicinal toluenediamines, ethylenediamine, sucrose, sorbitol, preferably glycerol, trimethylolpropane, monoethyl, diethyl and/or triethyl glycol, monopropylene, dipropylene and/or tripropylene glycol.

As alkylene oxides which can be employed for the preparation of alkoxylated amines, it is possible to use generally known alkylene oxides, for example ethylene oxide, propylene oxide and/or butylene oxide, preferably ethylene oxide and/or propylene oxide, with the alkylene oxides being able to be added onto the amine individually in admixture with one another or in blocks. For example, the amines can firstly be reacted only with ethylene oxide, only with propylene oxide, with a mixture of ethylene oxide and propylene oxide or else firstly with propylene oxide and subsequently with ethylene oxide. In the latter case, the reactivity of the alkoxylated amines toward isocyanates is increased as a result of the large proportion of primary hydroxyl groups.

The preparation of polyols by anionic polymerization can be carried out by means of generally known double metal cyanide (DMC) catalysis or by means of the known basic catalysis using metal hydroxides or tertiary amines. The type of catalysis influences the property profile of the polyols. The catalytic addition of alkylene oxides such as ethylene, propylene, butylene and/or styrene oxide occurs at the active centers of the starters or starter mixtures. Here, a plurality of alkylene oxides can be metered in and added on in succession and/or in admixture or in parallel. The type and amount of the alkylene oxides essentially determines the polyol properties and have a great influence on the property profile of the PUR foam. The alkoxylation is preferably catalyzed by means of alkali metal hydroxides, preferably potassium hydroxide. The catalysts can be used in generally known amounts and can, if appropriate, also be added during the alkoxylation.

The addition of the alkylene oxides onto the starter substances can be carried out by generally known methods. For example, the starter substances can be treated with the alkylene oxide at a temperature of, for example, from 70 to 160° C., preferably from 80 to 150° C., in a customary reactor (stirred tank reactors, tube reactors etc.) which is preferably equipped with customary facilities for cooling the reaction mixture. The alkylene oxides are preferably added in such a way that the reaction temperature is within a range from 70 to 160° C., preferably from 80 to 150° C. The reaction times usually depend on the temperature profile of the reaction mixture and are thus dependent, inter alia, on the batch size, the reactor type and the cooling facilities. The reaction can be carried out at pressures of from 0.1 MPa to 1 MPa, preferably from 0.1 MPa to 0.7 MPa.

The polyether polyalcohols prepared according to the present invention can be purified in a known manner, e.g. by almost neutralizing the reaction mixture with mineral acids such as hydrochloric acid, sulfuric acid and/or, preferably, phosphoric acid with organic acids or with carbon dioxide to a pH of usually from 6 to 8, removing the water from the polyether alcohol by customary vacuum distillation and filtering off the salts.

In the preparation of polyols by addition of alkylene oxides onto tertiary amines in the presence of a base, the amines are usually distilled off and partly reused or remain in the polyol to continue the catalysis in the PUR system.

Catalysis using metal hydroxides forms metal alkoxylates which are usually hydrolyzed with water and neutralized with acids. The use of mineral acids such as sulfuric, phosphoric and hydrochloric acids and of carbon dioxide leads to the formation of salts which can be separated off by filtration.

The use of organic acids, for example acetic, formic or 2-ethylhexanoic acid, results in the formation of soluble compounds. In most cases, the excess acid is separated off by vacuum distillation. The way in which the various crude polyetherols are treated depends on the use to which the polyol is to be put and the quality requirements which result therefrom.

When organic acids are used, the pH of the reaction product of the alkoxylation is preferably set to a value above 6, particularly preferably in the range from 7 to 8. Organic acids used in this neutralization step are preferably generally known organic acids, particularly preferably ethylhexanoic acid, lactic acid, formic acid, acetic acid and/or oxalic acid, in particular acetic acid. The organic acid, in particular acetic acid, used in this preferred embodiment for neutralization of the KOH offers the advantage that a soluble salt, in particular potassium acetate, is obtained in this case. The filtration step and thus the undesirable possibility of the sheet silicates being separated off is eliminated.

The sheet silicate(s) (are) is preferably present in the polyether alcohol in an amount of from 0.5 to 5% by weight, based on the total weight of the polyether alcohol.

A further object of the present invention was to develop a process for producing flexible foams, for example flexible integral foams, having improved properties, preferably an improved elasticity, in particular together with an improved elongation at break.

This object has been able to be achieved by a process for producing polyurethanes, for example compact or cellular, crosslinked or thermoplastic polyurethanes, e.g. flexible, semirigid or rigid polyurethane foams, preferably flexible polyurethane foams, by reacting
(a) polyisocyanates with
(b) compounds having hydrogen atoms which are reactive toward isocyanate groups,
   preferably in the presence of blowing agents, in which the polyether alcohols of the invention are used as (b) compounds having hydrogen atoms which are reactive toward isocyanate groups.

The production of polyisocyanate polyaddition products, for example polyurethanes, which may, if appropriate, contain urea and/or isocyanurate structures, by reacting (a) polyisocyanates with (b) compounds which are reactive toward isocyanates, if appropriate in the presence of (c) chain extenders andior crosslinkers, (d) catalysts which accelerate the reaction of the substances which are reactive toward isocyanates with isocyanates and, if appropriate, (e) blowing agents and/or (f) additives, is generally known, with the production of the preferred flexible foams preferably being carried out in the presence of blowing agents (e).

To produce the polyisocyanate polyaddition products, preferably the PU foams and in particular the flexible PU foams, by the process of the invention, use is made of, in addition to the polyol component (b) according to the present invention, the formative components (a) to (d), blowing agents (e) and, if appropriate, additives (f) which are known per se, about which the following may be said.

As isocyanates (a), preference is given to using tolylene 2,4- and/or 2,6-diisocyanate (TDI) and/or diphenylmethane 4,4′-, 2,2′- and/or 2,4′-diisocyanate (MDI), particularly preferably tolylene 2,4- and/or 2,6-diisocyanate, with the isocyanates being able to be modified if appropriate. For example, the isocyanates (a) can have ester, urea, biuret, allophanate, carbodiimide, isocyanurate, uretdione and/or urethane groups. Further isocyanates which can be used are generally known compounds, preferably diisocyanates, e.g. generally known aliphatic, cycloaliphatic, araliphatic and preferably aromatic polyfunctional isocyanates.

As compounds (b) which are reactive toward isocyanates, use is made, according to the invention, of the polyether alcohols presented at the outset which contain delaminated sheet silicates. In addition, further polyols selected from the group consisting of polyether polyols, polyester polyols, polythioether polyols, hydroxyl-containing polyesteramides, hydroxyl-containing polyacetals, hydroxyl-containing aliphatic polycarbonates and polymer-modified polyether polyols or mixtures of at least two of the polyols mentioned can be used if appropriate.

The polyurethane foams can be produced with or without concomitant use of chain extenders and/or crosslinkers (c). However, the use of chain extenders, crosslinkers or, if appropriate, mixtures thereof can prove to be advantageous for modifying the mechanical properties, e.g. the hardness. Chain extenders and/or crosslinkers used are polyhydric alcohols, preferably diols and/or triols, having molecular weights of preferably less than 499 g/mol, more preferably from 60 to 300 g/mol. Examples of suitable chain extenders are aliphatic, cycloaliphatic and/or araliphatic diols having from 2 to 14 carbon atoms, e.g. ethylene glycol, 1,3-propanediol, 1,10-decanediol, o-, m-, p-dihydroxycyclohexane, diethylene glycol, dipropylene glycol and preferably ethylene glycol, 1,3-butanediol, 1,4-butanediol, 1,6-hexanediol and bis-(2-hydroxyethyl)hydroquinone, and suitable crosslinkers are triols such as 1,2,4-, 1,3,5-trihydroxycyclohexane, trimethylolethane, glycerol and trimethylolpropane. If the compounds of the component (c) are used, they can be used in the form of mixtures or individually and are advantageously employed in amounts of from 1 to 40 parts by weight, preferably from 5 to 20 parts by weight, based on 100 parts by weight of the relatively high molecular weight polyhydroxyl compounds (b).

Possible catalysts (d) are generally known compounds, for example organic amines, for example triethylamine, triethylenediamine, tributylamine, dimethylbenzylamine, N,N,N′,N′-tetramethylethylenediamine, N,N,N′,N′-tetramethylbutanediamine, N,N,N′,N′-tetramethylhexane-1,6-diamine, dimethylcyclohexylamine, pentamethyldipropylene-triamine, pentamethyidiethylenetriamine, 3-methyl-6-dimethylamino-3-azapentol, dimethylaminopropylamine, 1,3-bisdimethylaminobutane, bis(2-dimethylaminoethyl) ether, N-ethylmorpholine, N-methylmorpholine, N-cyclohexylmorpholine, 2-dimethylaminoethoxyethanol, dimethylethanolamine, tetramethylhexamethylenediamine, dimethylamino-N-methylethanolamine, N-methylimidazole, N-(3-aminopropyl)imidazole, N-(3-aminopropyl)-2-methylimidazole, 1-(2-hydroxyethyl)imidazole, N-formyl-N,N′-dimethylbutylenediamine, N-dimethylaminoethylmorpholine, 3,3′-bis(dimethylamino)di-n-propylamine and/or bis(2-piperazinoisopropyl) ether, dimethylpiperazine, N,N′-bis(3-aminopropyl)ethylenediamine and/or tris(N,N-dimethylaminopropyl)-s-hexahydrotriazine or mixtures comprising at least two of the amines mentioned, with it also being possible to use relatively high molecular weight tertiary amines as are described, for example, in DE-A 28 12 256. Further catalysts which can be used for this purpose are customary organic metal compounds, preferably organic tin compounds such as tin(II) salts of organic carboxylic acids, e.g. tin(II) acetate, tin(II) octoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate. Preference is given to using tertiary aliphatic and/or cycloaliphatic amines, particularly preferably triethylenediamine.

As blowing agent (e), preference is given to using water which reacts with the organic, modified or unmodified polyisocyanates (a) to form carbon dioxide and urea groups and thereby influences the compressive strength of the end products. To achieve the desired foam density, the water is usually used in amounts of from 0.05 to 6% by weight, preferably from 0.1 to 5% by weight, based on the weight of the formative components (a) to (c). Further blowing agents (d) which can be used in place of water or preferably in combination with water are low-boiling liquids which vaporize under the action of the exothermic polyaddition reaction and advantageously have a boiling point under atmospheric pressure in the range from −40 to 90° C., preferably from 10 to 50° C., or gases. The liquids of the abovementioned type and gases suitable as blowing agents can, for example, be selected from the group consisting of alkanes and alkenes, e.g. propane, n-butane and isobutane, n-pentane and isopentane and preferably industrial pentane mixtures, cycloalkanes such as cyclobutane, cyclopentane, cyclohexane and preferably cyclopentane and/or cyclohexane, dialkyl ethers such as dimethyl ether, methyl ethyl ether and diethyl ether, cycloalkylene ethers such as furan, ketones such as acetone, methyl ethyl ketone, carboxylic esters such as ethyl acetate and methyl formate, carboxylic acids such as formic acid, acetic acid and propionic acid, fluoroalkanes which are degraded in the troposphere and therefore do not damage the ozone layer, e.g. trifluoromethane, difluoromethane, difluoroethane, tetrafluoroethane and heptafluoroethane, and gases such as nitrogen, carbon monoxide and noble gases such as helium, neon and krypton.

The most advantageous amount of low-boiling liquids and gases, which can in each case be used individually as liquid or gas mixtures or as gas/liquid mixtures, depends on the density which is to be achieved and the amount of water used. The required amounts can easily be determined by means of simple tests. Satisfactory results are usually obtained using amounts of liquid from 0.5 to 20 parts by weight, preferably from 2 to 10 parts by weight, and amounts of gas of from 0.01 to 30 parts by weight, preferably from 2 to 20 parts by weight, in each case based on 100 parts by weight of the components (b) and, if present, (c). Preferred blowing agents (e) are water, alkanes having from 3 to 7 carbon atoms, cycloalkanes having from 4 to 7 carbon atoms or mixtures comprising at least two of the compounds named as preferred blowing agents.

To produce the polyisocyanate polyaddition products, in particular the flexible polyurethane foams, by the process of the invention, additives (f) can be used if appropriate. Examples of such additives are: surface-active substances, foam stabilizers, cell regulators, lubricants, fillers, dyes, pigments, flame retardants, hydrolysis inhibitors, fungistatic and bacteriostatic substances.

To produce the foams, (a), (b) and, if appropriate, (c) can be reacted in such amounts that the equivalence ratio of NCO groups of the polyisocyanates (a) to the sum of the reactive hydrogen atoms of the components (b) and, if present, (c) is 0.70-1.50:1, preferably 0.85-1.15:1 and in particular 0.9-1.1:1.

The foams can be produced by the prepolymer or preferably the one-shot method with the aid of the low-pressure technique or the high-pressure technique in open or closed, advantageously heatable molds, for example metallic molds, e.g. molds made of aluminum, cast iron or steel, or molds made of fiber-reinforced polyester or epoxy molding compositions.

It has been found to be particularly advantageous to employ the two-component process and to combine the formative components (b), (d), (e) and, if appropriate, (c) and (f) to form the component (A) and use the organic polyisocyanates, modified polyisocyanates (a) or mixtures of the polyisocyanates mentioned and, if appropriate blowing agents (d) as component (B).

The starting components are usually mixed at a temperature of from 15 to 80° C., preferably from 25 to 55° C., and can be introduced under atmospheric pressure into an open mold or under atmospheric or superatmospheric pressure into a closed mold. Mixing can be carried out mechanically by means of a stirrer or a stirring screw or under high pressure by the countercurrent injection process. The mold temperature is advantageously from 20 to 120° C., preferably from 30 to 80° C. and in particular from 45 to 60° C. If, for example, flexible polyurethane moldings are produced with compaction, the degree of compaction is usually in the range from 1.1 to 8.3, preferably from 2 to 7 and in particular from 2.4 to 4.5.

The amount of reaction mixture introduced into the mold is advantageously such that the moldings obtained have an overall density of from 0.01 to 0.9 g/cm³, preferably from 0.03 to 0.7 g/cm³.

The flexible polyurethane foams can also be produced by the slabstock foam method. The slabstock foams usually have densities of from 0.02 to 0.06 g/cm³.

The slabstock foams and flexible polyurethane foam moldings produced by the process of the invention are used, for example, in the motor vehicle industry, e.g. as armrests, headrests and safety lining in the motor vehicle interior, and also as bicycle or motor cycle saddles, shoe soles and as inners for ski boots. They are also suitable as upholstery material in the furniture industry and the automobile industry.

### EXAMPLES

### Synthesis Example

100 g of glycerol, 50 g of 48% strength aqueous potassium hydroxide solution and 78.2 g of Cloisite 30B were placed in a 2 l pressure autoclave provided with stirrer, reactor heating and cooling, metering facilities for solid and liquid substances and alkylene oxides and also facilities for blanketing with nitrogen and a vacuum system and the mixture was heated to 110° C. while stirring. The mixture was homogenized well and reacted with 814 g of propylene oxide at 110° C. rising to 112° C. At the beginning of the reaction, the pressure rose to 6.5 bar and was maintained at about 5 bar until the end of the reaction. After the end of the metered addition, an after-reaction was allowed to take place at 120° C. for 4 hours. This gave an alkaline product having an OHN of 201 mg KOH/g.

400 g of this alkaline prepolymer were reacted at 110° C. with 1046 g of propylene oxide and, after this had reacted, with 317.5 g of ethylene oxide in the above-described reactor. The reaction temperature was likewise 110° C. The product was hydrolyzed with 2% of water, based on the batch size, neutralized with 110% of the stoichiometric amount of acetic acid and vacuum-distilled and had the following parameters:

Hydroxyl number: 28.9 mg KOH/g

Acid number: 0.150 mg KOH/g

Viscosity at 25° C.: 2279 mPas

pH: 8.2

Water content: 0.027%

The product is homogeneous.

Foam Production:

Basic formulation

A component
96.06 parts of a polyetherol (A) having an OHN of 25-30 mg KOH/g and prepared by polyaddition of propylene oxide and ethylene oxide onto glycerol
5.0 parts of a polyetherol (B) having an OHN of 39-45 mg KOH/g and prepared by polyaddition of propylene oxide and ethylene oxide onto glycerol
0.5 part of stabilizer Tegostab B4113
0.2 part of N-formyl-N,N-dimethylbutylenediamine
0.1 part a 70% strength solution of bisdimethylaminoethyl ether in dipropylene glycol
3.0 parts of water

B component
42.1 parts of monomeric MDI (2.4% 2,2′; 49.5% 2,4′; 48.1% 4,4′)
20.4 parts of monomeric MDI (98.1% 4,4′; 1.9% 2,4′)
37.5 parts of polymeric MDI having an NCO content of 31% and a viscosity of 200 mPa s^{25° C.}

An index of 90 was employed.

A polyurethane foam was produced from 100 parts by weight of the A component and 42.9 parts of the B component by manual foaming. The reaction mixture was stirred by means of a disk stirrer from Vollrath at a speed of about 1800 revolutions per minute. Polyol A in the basic formulation was replaced by the polyether alcohol which had been prepared according to the invention and contained 1:12% of exfoliated sheet silicate. The foam obtained using the sheet silicate had, at a foam density of 40±2 g/l, an improved elongation at break of 91% compared to an elongation at break of 79% (measured in accordance with DIN EN ISO 1798) of the foam without sheet silicate.

WAXS (wide angle X-ray scattering) studies on both the polyetherol and the foam show no signals for a sheet reflection. This indicates exfoliation of the sheet silicates. Transmission electron migrographs of the foam show largely isolated sheets, which means that the sheet silicate used has been exfoliated by the alkoxylation.

1. A process for preparing polyether alcohols, wherein the alkoxylation is carried out in the presence of sheet silicates.

2. The process according to claim 1, wherein the sheet silicate is mixed with the starter substance or substances and alkylene oxide is subsequently introduced.

3. The process according to claim 1, wherein the alkoxylation is catalyzed by means of alkali metal hydroxides.

4. The process according to claim 3, wherein the pH of the reaction product of the alkoxylation is set to a value of greater than 6 by means of organic acids.

5. The process according to claim 1, wherein the sheet silicate(s) is (are) present in the polyether alcohol in an amount of from 0.5 to 5% by weight, based on the total weight of the polyether alcohol.

6. A polyether alcohol obtainable by a process according to claim 1.

7. A polyether alcohol comprising exfoliated sheet silicates.

8. A process for producing polyurethanes by reacting
(a) polyisocyanates with
(b) compounds having hydrogen atoms which are reactive toward isocyanate groups,
wherein polyether alcohols according to claim 6 are used as (b) compounds having hydrogen atoms which are reactive toward isocyanate groups.

9. The process according to claim 8 for producing flexible polyurethane foams, wherein the reaction of (a) with (b) is carried out in the presence of blowing agents.

10. A polyurethane obtainable by a process according to claim 8.
